(19) United States
(12) Patent Application Publication
(10) Pub. No.: US 2025/0172800 A1
(43) Pub. Date: May 29, 2025

(54) THREE-DIMENSIONAL RANDOM ACCESS SCANNING

(71) Applicants: Caroline Berlage, Berlin (DE); Benjamin Judkewitz, Berlin (DE)

(72) Inventors: Caroline Berlage, Berlin (DE); Benjamin Judkewitz, Berlin (DE)

(21) Appl. No.: 18/933,987

(22) Filed: Oct. 31, 2024

Related U.S. Application Data
(60) Provisional application No. 63/595,270, filed on Nov. 1, 2023.
(60) Provisional application No. 63/611,558, filed on Dec. 18, 2023.

(51) Int. Cl. G02B 26/10; G02B 21/16; G02B 26/06; G02B 26/08

(52) U.S. Cl. CPC G02B 26/101; G02B 21/16; G02B 26/06; G02B 26/0833

(57) ABSTRACT

High-speed volumetric imaging is useful for observing fast and distributed processes such as neuronal activity. Multiphoton microscopy helps to mitigate scattering effects inside tissue, but the standard raster scanning approach limits achievable volume rates. Random-access scanning can lead to a considerable speed-up by sampling pre-selected locations; however, existing techniques based on acousto-optic deflectors may still be limited to a point rate that is low. This limitation may restrict the number of parallel targets at the high acquisition rates necessary, for example, in voltage imaging or imaging of fast synaptic events. Disclosed herein is a method for three-dimensional (3D) random-access scanning at up to 340 kHz rate using a single 1D phase modulator in a compact setup. The potential of this method is demonstrated by imaging synaptic events with fluorescent glutamate sensors in mammalian organotypic slices as well as in zebrafish larvae.

### INCORPORATION BY REFERENCE TO ANY PRIORITY APPLICATIONS

This application claims benefit under 35 U.S.C. § 119(e) of U.S. Provisional Application No. 63/595,270, titled “THREE-DIMENSIONAL RANDOM ACCESS SCANNING”, filed on Nov. 1, 2023, as well as U.S. Provisional Application No. 63/611,558, titled “THREE-DIMENSIONAL RANDOM ACCESS SCANNING”, filed on Dec. 18, 2023, both of which are hereby incorporated herein by reference in their entirety.

### BACKGROUND

### Field of Disclosure

Embodiments of the subject matter described herein are related generally to beam steering, and more particularly to random access scanning such as 3D random access scanning, which can be employed, for example, for two-photon laser scanning microscopy as well as other applications.

### Description of the Related Art

Optical microscopy plays a crucial role in biomedical research. For imaging living tissues, one of the most widespread techniques is two-photon (2P) laser scanning microscopy, because this technique enables high-resolution imaging at depth. With such scanning microscopy, fluorescence is excited nonlinearly in the vicinity of a moving focus, thus reducing the susceptibility to scattering.

The imaging speed of such laser scanning techniques, however, is limited by the inertia of scanning mirrors for lateral scanning, and even more by mechanisms for axial scanning. Fundamentally, imaging rate is also limited by the fluorescence lifetime, which can restrict the pixel dwell time to a minimum on the order of several nanoseconds. Especially for volumetric imaging, this severely limits the rate at which dynamic processes can be observed.

When observing biological activity, particularly in neuroscience, structures are often sparse and not all points within the field of view (FOV) are equally relevant. Random access microscopy can exploit this fact by employing targeted sampling of pre-selected locations.

### SUMMARY

Various apparatus and methods described herein can provide for random access scanning that may be employed, for example, for scanning microscopy as well as for other purposes. In various methods for 3D random-access scanning up to 340 kHz, for example, a MEMs-based 1D spatial light modulator in a compact and modular optical setup can be used in conjunction with existing multiphoton microscopes. In addition to raising the speed of random access point scanning by nearly an order of magnitude, the method's potential is demonstrated by volumetrically recording fast synaptic events in organotypic slices and zebrafish larvae at nearly 100 sites simultaneously.

For example, as described herein, a beam steering apparatus may be configured to receive a light beam having a cross-section orthogonal to propagation of the light beam. The cross-section extends along first and second orthogonal (x and y) axes, with the beam propagating along a longitudinal (z) axis orthogonal to the first and second orthogonal axes. The example apparatus comprises a 1D phase spatial light modulator having an elongate-shaped active area with a length in a first direction that is greater than a width in a second orthogonal direction. The active area is configured to modulate the phase of light incident thereon. The apparatus further comprises optics comprising at least one anamorphic lens and a plurality of reflectors. The optics is configured to:
(i) focus the beam down in the second direction more than the first direction to form a first line focus on a first segment of the length of the active area of the 1D phase spatial light modulator, the first line focus extending along the first axis of the beam cross-section,
(ii) increase collimation of light received from the first segment of the 1D phase spatial light modulator in the second direction,
(iii) rotate the beam cross-section azimuthally about the longitudinal axis such that the second axis is more aligned with the first direction than the second direction,
(iv) focus the beam down in the second orthogonal direction more than the first direction to form a second line focus on a second segment of the length of the active area of the 1D phase spatial light modulator, the second line focus extending along the second axis of the rotated beam cross-section, and
(v) increase collimation of the light received from the second segment of the 1D phase spatial light modulator in the second direction.

Another example beam steering apparatus configured to receive a light beam comprises a single 1D phase spatial light modulator, at least one anamorphic lens, and electronics. The single 1D phase spatial light modulator has an elongate-shaped active area with a length in a first direction that is greater than a width in a second orthogonal direction. The active area is configured to modulate the phase of light incident thereon. The at least one anamorphic lens is configured to focus the beam down more in one direction than an orthogonal direction to form a first line focus along the length of the active area of the 1D phase spatial light modulator. The electronics is configured to adjust the 1D phase spatial light modulator to steer the beam in two orthogonal lateral directions (x and y) and focus the beam at different distances in a third longitudinal direction (z) in a manner so as to provide 3D random access point scanning.

Another example beam steering apparatus configured to receive a light beam comprises at least one 1D phase spatial light modulator, at least one anamorphic lens and electronics. The at least one 1D phase spatial light modulator has an elongate-shaped active area with a length in the first direction that is greater than a width in the second orthogonal direction. The active area is configured to modulate the phase of light incident thereon. The at least one anamorphic lens is configured to focus the beam down more in one direction than in an orthogonal direction to form a first line focus on the length of the active area of the at least one 1D phase spatial light modulator. The electronics is configured to adjust the at least one 1D phase spatial light modulator to steer the beam in two lateral directions (x and y) and focus the beam at different distances along a third direction (z) in a manner so as to provide 3D random access point scanning.

Another example beam steering apparatus configured to receive a light beam comprises at least one phase spatial light modulator, at least one optical element configured to focus the beam onto the at least one phase spatial light modulator, and electronics. The electronics is configured to adjust the at least one phase spatial light modulator to steer the beam in two lateral directions (x and y) and focus the beam at different distances along a third direction (z) in a manner so as to provide 3D random access point scanning. The electronics and the at least one phase spatial light modulator are configured such that the beam steering apparatus can provide 3D random-access point scanning at refresh rates of at least 300 kHz.

Other apparatus, methods, designs and application are described herein.

### BRIEF DESCRIPTION OF THE DRAWINGS

FIG. 1A schematically illustrates raster scanning a focused beam across the sample to generate a detailed 3D image.

FIG. 1B schematically illustrates three-dimensional random-access imaging. Random-access scanning allows faster volume rates by sampling only pre-selected locations.

FIG. 2 is a schematic drawings of a spatial light modulator (SLM).

FIGS. 3A-3C schematically illustrates how a spatial light modulator may provide for lateral scanning and axial scanning.

FIGS. 4A and 4B schematically illustrates scattering/aberration correction.

FIG. 4A shows how scattering destroys focus, while FIG. 4B shows how an engineered wavefront can recover focus.

FIGS. 5A and 5B schematically illustrate a setup using two (hypothetically transmissive) linear SLMs and four cylindrical lenses. A cylindrical lens focuses the initially collimated beam to a line on the first SLM, where it is phase modulated along the first dimension. A second cylindrical lens re-collimates the beam 26 before the same process occurs rotated by 90 degrees. Using a scan lens and tube lens, the SLM plane is then imaged onto a back focal plane of a microscope objective.

FIGS. 6A-6C is a 3D visualization of a compact scanning module. This folded setup uses only one SLM and cylindrical lens. FIGS. 6A-6C show the SLM, cylindrical lens, and retroreflector. In FIG. 6C, a beam is shown entering on the top left quadrant (1) and is first modulated on the front half of the SLM (2). The custom retroreflector rotates the beam at 90 degrees (3), so the same cylindrical lens and SLM can be reused in the back half (4-5). The modulated beam exits the module at the bottom right (6).

FIGS. 7A and 7B schematically depict an unfolded setup to illustrate the beam path. FIG. 7A is a top view and FIG. 7B is a side view. The SLM is reflective, not transmissive in this unfolded depiction of 3D scanning with a linear spatial light modulator.

FIGS. 8A-8C provide spatial and temporal characterization. In FIG. 8A, for example, a three-dimensional field of view (FOV) is visualized with 1 m diameter beads using a 25× objective with effective numerical aperture (NA) of 0.63. FIG. 8B provides temporal switching characteristics. The phase pattern switches between a bright and dark target within the FOV. The phase modulator is updated at 100 kHz and the photomultiplier (PMT) signal is acquired at 2 MHz. The 10-90% switching time is 2.75 μs±0.25 μs. In FIG. 8C, bright and dark targets alternate as in FIG. 8B. Both the maximum 48 and mean 50 values of the bright target, normalized to the value at 10 kHz, are plotted at each sampling rate.

FIGS. 9A-9B demonstrate application to organotypic slices at 250 kHz. FIGS. 9A-9B are, for example, results of 3D random access microscopy using iGluSnFR3 in mouse organotypic slices at a 250 kHz refresh rate. FIG. 9A is a raster-scanned overview stack of an organotypic slice labeled with iGluSnFR3. A Gamma correction was applied to emphasize dimmer structures (for visibility in this panel, not during analysis). Manually selected targets for random-access scanning are marked as (blue) dots. To increase overall activity, slices were imaged in a solution containing 20 mM KCl and 0.2 mM 4AP. FIG. 9B shows change in fluorescence dF/F0 acquired at 250 kHz. FIG. 9C is a zoom of the region in FIG. 9B marked with a (black) rectangle.

FIGS. 10A-10C demonstrate application to zebrafish at 340 kHz. FIGS. 10A-10C are, for example, results of 3D random access microscopy using iGluSnFR3 in larval zebrafish olfactory bulb at a 340 kHz refresh rate. FIG. 10A is a raster scanned overview stack of part of the olfactory bulb of a 3 dpf zebrafish larva. FIG. 10B shows change in fluorescence dF/F0 acquired at 340 kHz. FIG. 10C is a zoom of the region in FIG. 10B marked with a (black) rectangle.

FIG. 11 is a plot of diffraction efficiency versus phase stroke.

FIGS. 12A and 12B shows point spread functions (PSF), namely, PSFs for 25×/40×. Maximum intensity projections in the XY, XZ and YZ planes using a 40×/0.8NA objective (FWHM x: 1.0 μm, y: 0.8 μm, z: 3.5 μm) are shown in FIG. 12A and using a 25× objective with effective illumination NA of 0.63 due to underfilling (FWHM x: 1.6 μm, y: 1.3 μm, z: 9.3 μm) are shown in FIG. 12B.

FIGS. 13A-13C illustrate adaptive optics for system correction. FIG. 13A is a raster-scanned overview of 1 μm beads (yellow-green FluoSpheres, ThermoFisher) dispersed in agarose. FIG. 13B includes profiles along the lines shown in FIG. 13A, depicting an increase in signal after system correction (red curve) as compared to no correction (grey curve). FIG. 13C shows contributions of individual Zernike polynomials to the system correction, which can be approximated by a linearly separable pattern. Numbers correspond to Noll indices: 5—vertical astigmatism, 6—vertical trefoil, 7—vertical coma, 8—horizontal coma, 9—oblique trefoil, 12—1st spherical aberration, 13—vertical 2nd astigmatism, and 14—vertical quadrafoil.

FIGS. 14A-14B show the field of view (FOV) using the 40×/0.8NA objective.

FIG. 14A shows Maximum intensity projections along all three axes visualized using a fluorescein solution. FIG. 14B shows FOV visualization using 1 μm diameter beads (yellow-green FluoSpheres, ThermoFisher).

FIGS. 15A-15C show 3D random access microscopy using iGluSnFR3 in larval zebrafish olfactory bulb at a 100 kHz refresh rate. FIG. 15A is a raster scanned overview stack of part of the olfactory bulb of a 4 dpf zebrafish larva. Manually selected targets for random-access scanning are marked as blue dots. FIG. 15B shows change in fluorescence dF/F0 acquired at 100 kHz. FIG. 15C is a zoom in of the region in FIG. 15B marked with a (black) rectangle.

### DETAILED DESCRIPTION

As discussed above, not all points within the field of view (FOV) are equally relevant. When observing biological activity, for example, particularly in neuroscience, structures are often sparse. Random access microscopy can take advantage of the fact that not all points in the FOV are equally relevant by employing targeted sampling of pre-selected locations.

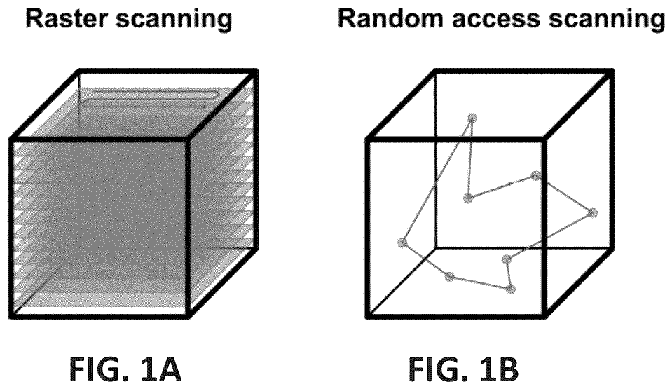

Random access scanning may be thus be employed for fast 3D imaging. A comparison of raster scanning with random access scanning is presented in FIGS. 1A and 1B. FIG. 1A illustrates raster scanning a focused beam across the sample to generate a detailed 3D image. As discussed above, volume acquisition rates are limited by inertia and by the fluorescence lifetime FIG. 1B, by contrast, schematically illustrates three-dimensional random-access imaging. Random-access scanning allows faster volume rates by sampling only pre-selected locations.

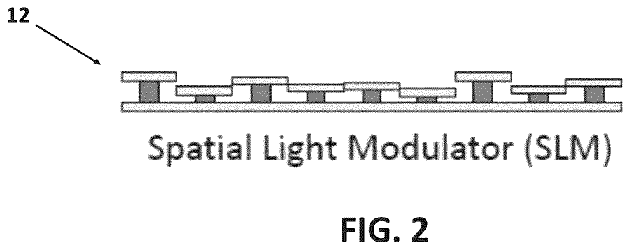

An example spatial light modulator (SLM) 12 is shown in FIG. 2. The spatial light modulator may comprise, for example, a phase spatial light modulator such as a 1D phase spatial light modulator. In various implementations, the spatial light modulator comprises a reflective 1D phase spatial light modulator. The reflective 1D phase spatial light modulator may comprise a MEMS reflector. For example, the MEMS reflector may comprise a plurality of reflective ribbons that can be displaced toward and/or away from an electrode. The reflective 1D phase spatial light modulator may have a refresh rate of at least 300 kHz.

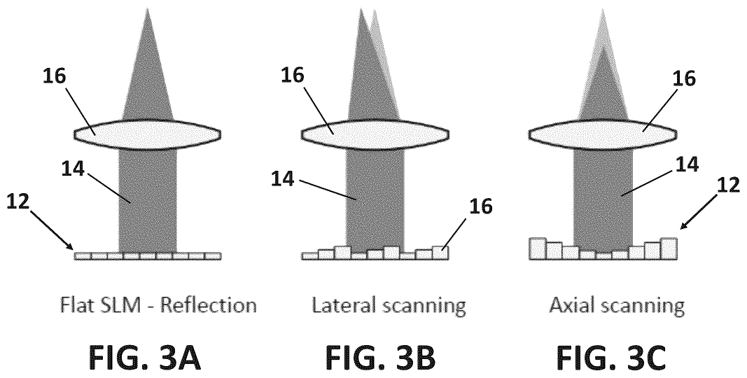

FIG. 3A shows an SLM 12 that is flat providing reflection of a light beam 14 through a lens 16 so as to be focused to a location, e.g., to a point. FIG. 3B depicts the SLM providing for lateral scanning while FIG. 3C shows the SLM providing for axial scanning. As discussed below, electronics may be configured to adjust the 1D phase spatial light modulator to steer the beam in two orthogonal lateral directions (e.g., x and y) and focus the beam at different distances in a third longitudinal direction (z) in a manner so as to provide 3D random access point scanning.

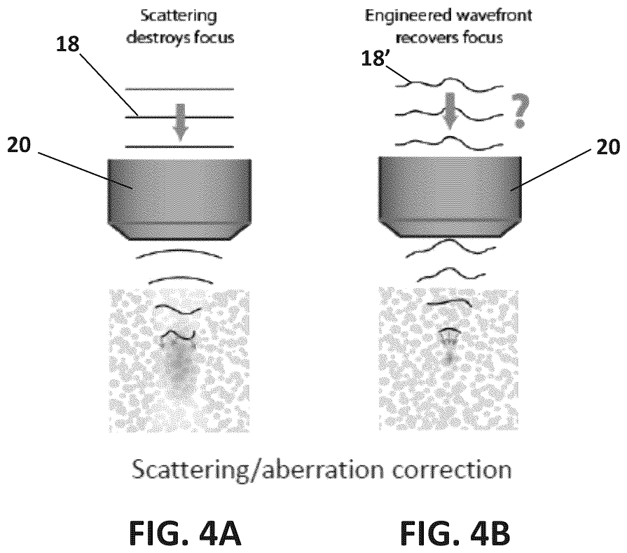

The SLM-based random access can enable arbitrary patterns. For example, the electronics may be further configured to provide adaptive optical correction by causing the 1D phase spatial light modulator to offset aberration in the system and/or in the sample. FIGS. 4A and 4B schematically illustrates such scattering/aberration correction. A wavefront 18 is shown in FIG. 4A propagating through a microscope objective 20 to be focused down. However, scattering alters the wavefront 18 and destroys the focus. FIG. 4B schematically illustrates how an engineered wavefront 18′ can recover focus.

Recent work on 1D beam steering with reflective MEMS-based linear spatial light modulators has demonstrated update rates of up to 350 kHz. Whether such devices could be used as a basis for ultrafast 3D scanning was considered.

By using two linear modulators in a crossed configuration, it should in principle be possible to create any linearly separable 2D pattern. This includes both lateral deflections and defocus (to access the third dimension). Additionally, many Zernike polynomials can be closely approximated by linearly separable patterns to correct for aberrations.

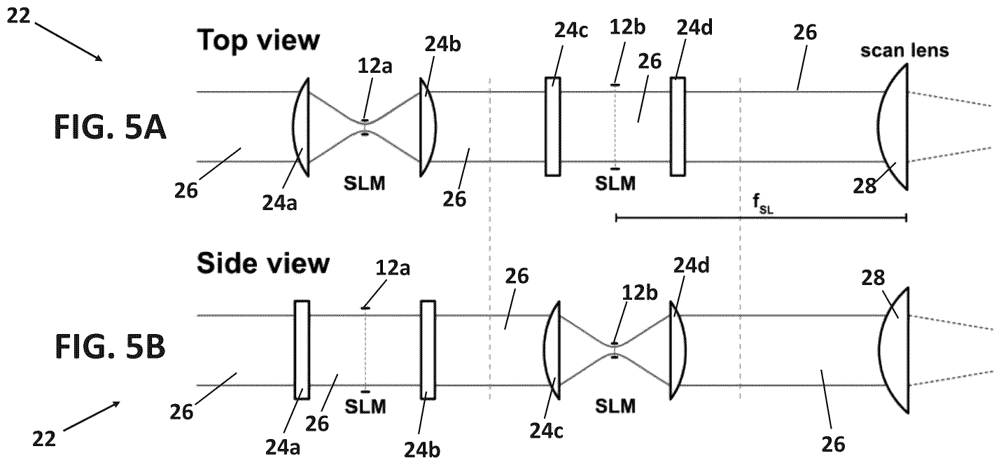

To illustrate the principle of 3D modulation using linear modulators, a setup 22 using two (hypothetically transmissive) linear SLMs 12a, 12b and four cylindrical lenses 24a, 24b, 24c, 24d is shown in FIGS. 5A and 5B. In short, a cylindrical lens 24a focuses the initially collimated beam 26 to a line on the first SLM 12a, where it is phase modulated along the first dimension. A second cylindrical lens 24b re-collimates the beam 26 before the same process occurs rotated by 90 degrees. Using a scan lens 28 and tube lens (not shown), the SLM plane is then imaged onto a back focal plane of a microscope objective (not shown). As illustrated, the setup 22 includes many components that are difficult to align and synchronize at high speed.

Several key hurdles may accompany this basic design and hardware. First, as a beam deflection by the first SLM 12a will shift the second line focus up or down, the short axis of the second SLM's 12b active area may limit the scanning range of the first SLM. This may necessitate a characterization of effective pixel size along this axis and the use of short focal length lenses. As currently available phase modulators are reflective, short focal lengths may make it difficult to separate input and output. The second hurdle is to adequately synchronize the SLMs 12a, 12b, ideally at a multiple of their refresh rate (i.e., ≥1 MHz). Finally, the primary device for high-speed scanning at hundreds of kHz (e.g., using Silicon Light Machines F1088-P) is designed for a full stroke at blue and UV wavelengths, falling short of full phase modulation at the near-infrared (NIR) wavelengths used for biological multiphoton imaging.

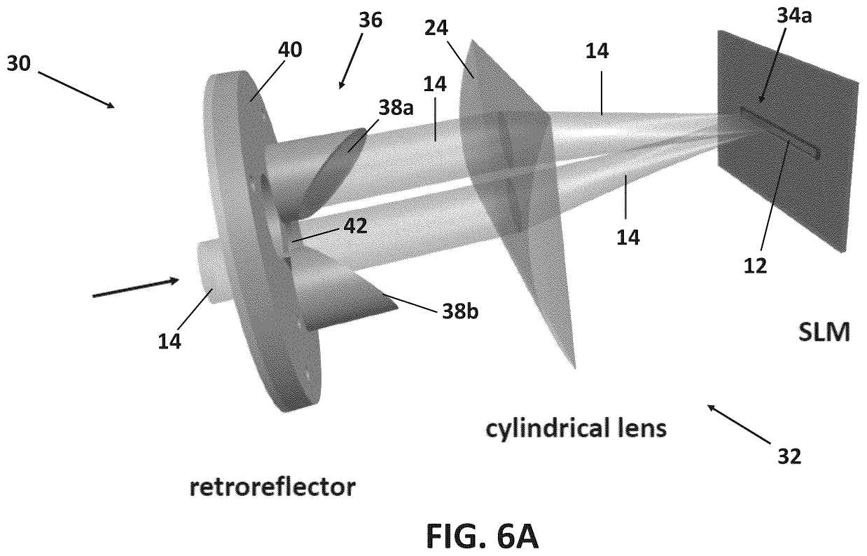

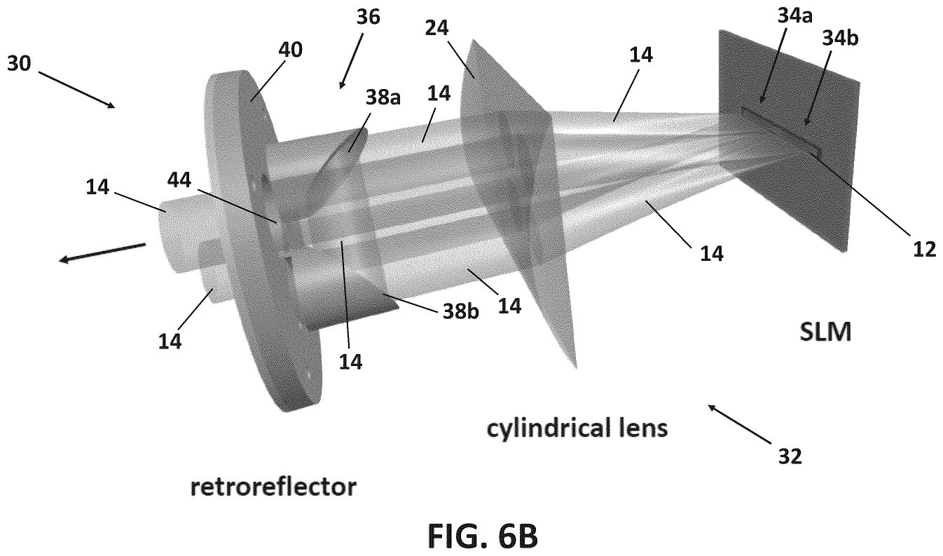

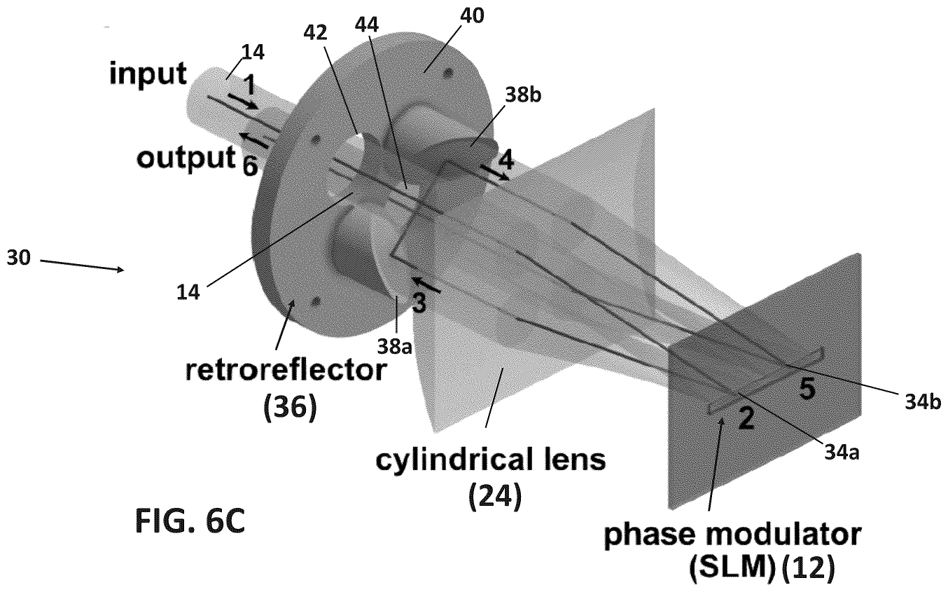

The first two hurdles can be addressed with the design shown in FIGS. 6A-6C. FIGS. 6A-6B show a beam steering apparatus or module 30 configured to receive a light beam 14 having a cross-section orthogonal to propagation of the light beam. The cross-section extends along first and second orthogonal (x and y) axes. The beam 14 propagates along a longitudinal (z) axis orthogonal to the first and second orthogonal axes. The apparatus/module 30 comprises a 1D phase spatial light modulator 12 and optics 32. The 1D phase spatial light modulator 12 has an elongate-shaped active area with a length in a first direction that is greater than a width in a second orthogonal direction. The active area is configured to modulate the phase of light incident thereon. The optics 32 comprises at least one anamorphic lens 24 and a plurality of reflectors 38. The optics 32 may be configured to focus the beam 14 down in the second direction more than the first direction to form a first line focus on a first segment 34a of the length of the active area of the 1D phase spatial light modulator 12 (the first line focus extending along the first axis of the beam cross-section). The optics 32 may be configured additionally to increase collimation of light received from the first segment 34a of the 1D phase spatial light modulator 12 in the second direction. The optics 32 may be configured additionally to rotate the beam cross-section azimuthally about the longitudinal axis such that the second axis is more aligned with the first direction than the second direction. The optics 32 may be configured to also focus the beam 14 down in the second orthogonal direction more than the first direction to form a second line focus on a second segment 34b of the length of the active area of the 1D phase spatial light modulator 12 (the second line focus extending along the second axis of the rotated beam cross-section). The optics 32 may be configured to additionally increase collimation of the light received from the second segment of the 1D phase spatial light modulator 12 in the second direction.

As illustrated, the plurality of reflectors 38a, 38b may be configured to reflect light reflected from the 1D phase spatial light modulator 12 back to the 1D phase modulator. Additionally, the first and second reflectors 38a, 38b may be arranged with respect to each other along a diagonal to the length of the 1D phase spatial light modulator so as to azimuthally rotate the beam about said longitudinal axis. The plurality of reflectors 38a, 38b may, for example, be arranged to rotate the beam cross-section by 80-110°. For example, the plurality of reflectors 38 may be arranged to rotate the beam cross-section by 90°.

The anamorphic lens 24 may comprise a cylindrical lens or an acylindrical lens. The anamorphic lens 24 may, for example, comprise an achromatic cylindrical lens. As shown, the anamorphic lens 24 may be disposed such that the light beam is transmitted through the anamorphic lens both when incident on the 1D phase spatial light modulator 12 and when reflected therefrom.

As discussed above, the plurality of reflectors 38 may comprise first and second reflectors 38a, 38b arranged with respect to each other along a diagonal to the first and second directions so as to azimuthally rotate the beam cross-section. The first reflector 38a, for example, may be disposed to receive light focused on the first portion 34a of said 1D phase spatial light modulator 12 and to reflect light from the first portion of the 1D phase modulator onto the second reflector 38b. The second reflector 38b may be disposed to reflect light from the first reflector 38a onto the second portion 34b of the 1D phase spatial light modulator 12.

In some designs, the at least one anamorphic lens 24 comprises an anamorphic lens and the plurality of reflectors 38a, 38b are configured such that the light beam passes through a first quadrant of the anamorphic lens, is reflected from the first segment 34a of the 1D phase spatial light modulator 12 through a second quadrant of the anamorphic lens, is reflected from the plurality of reflectors 38a, 38b through a third quadrant of the anamorphic lens and is reflected from the 1D phase modulator through a fourth quadrant of the anamorphic lens.

The first and second segments 34a, 34b may each extend along 40-60% of the length of the 1D phase spatial light modulator 12. Likewise, the first and second segments 34a, 34b may each extend along about half of the length of the 1D phase spatial light modulator 12.

In FIG. 6C, additionally shows a beam 14 entering on the top left quadrant (1). The beam 14 is first modulated on the front half 34a of the SLM 12 (2). The custom retroreflector 36 rotates the beam 14 at 90 degrees (3), so the same cylindrical lens 24 and SLM 12 can be reused in the back half (4-5). The modulated beam 14 exits the module 30 at the bottom right (6) in this example.

The synchronization challenge discussed above is solved by using the same SLM device 12 twice, while rotating the beam 14 between passes. This approach also allows reduction of focal lengths and produces a compact optical module 30. As shown in FIG. 6A, for example, a collimated, approximately 10 mm-diameter beam 14 enters through an input port 42 in the lower left quadrant of a custom mount 40. The cylindrical lens 24 creates a line focus on the left half 34a of the phase modulator 12, which is then reflected and recollimated in the upper left quadrant before reaching the retroreflector 36. Two elliptical mirrors 38a, 38b mounted on the retroreflector 36 reflect the beam 14 back (see FIG. 6B) towards the lower right quadrant of the cylindrical lens 24 and, at the same time, rotate the beam by 90 degrees, so that the second modulation on the phase modulator 12 is orthogonal to the first. The beam 14 then exits the module 30 through an output port 44 in the top right quadrant. The SLM plane is imaged onto the back focal plane of an objective with unit magnification using two achromatic lenses as scan and tube lenses. Unmodulated light and unwanted diffraction orders are blocked by a rectangular absorptive aperture at the scan lens focal plane.

This module 30 can thus be added to a conventional multiphoton microscope. Accordingly, a multiphoton fluorescence microscope may comprise the module 30. The multiphoton fluorescence microscope may further comprise a laser light source. The multiphoton fluorescence microscope may also further comprise a microscope objective.

Accordingly, the beam steering apparatus may further comprise a microscope objective. Furthermore, the 1D phase spatial light modulator 12 may be imaged to a back focal plane of the microscope objective. The beam steering apparatus may further comprise achromatic lenses configured to image the 1D phase spatial light modulator 12 onto said back focal plane of the microscope objective. The beam steering apparatus may also further comprise an aperture at a focal plane of one of the achromatic lenses that is configured to block unmodulated light and/or one or more unwanted diffractive orders.

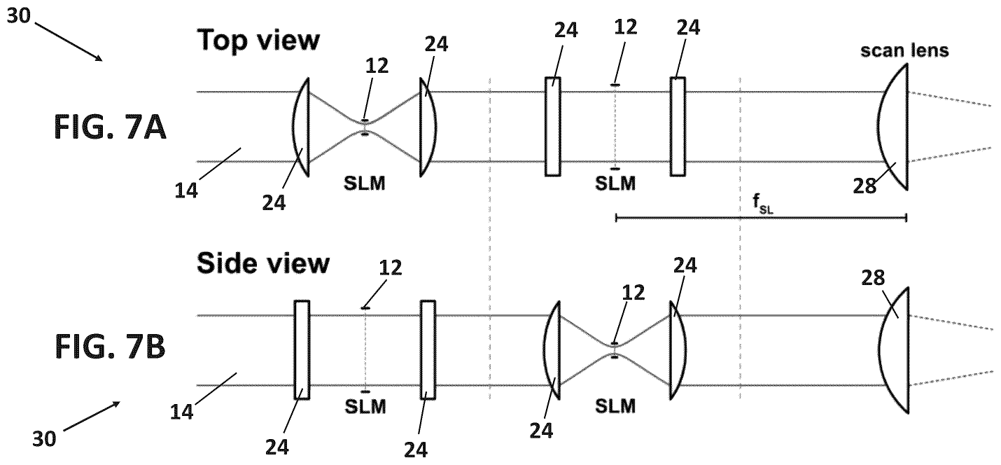

FIGS. 7A and 7B schematically depict an unfolded setup to illustrate the beam path. FIG. 7A is a top view and FIG. 7B is a side view. The SLM 12 is reflective, not transmissive, in this unfolded depiction of 3D scanning with a linear spatial light modulator. As shown a collimated beam 14 enters the module 30. The cylindrical lens 24 creates a line focus on the SLM 12, where the first axis is modulated. The beam 14 is recollimated and the focused orthogonal to the first axis, modulated on the SLM 14, and recollimated. A scan lens 28 and tube lens (not shown) image the SLM plane onto the objective's back aperture.

### Results and Applications

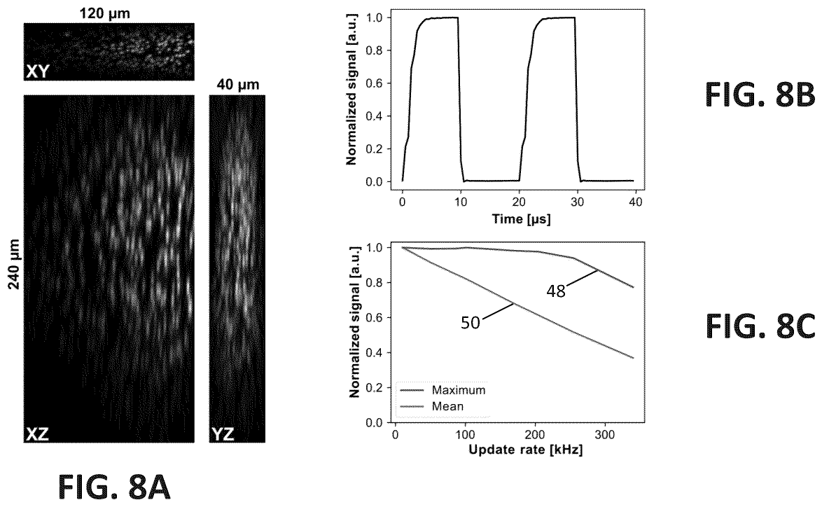

FIGS. 8A-8C provide spatial and temporal characterization. In FIG. 8A, for example, a three-dimensional field of view (FOV) is visualized with 1 μm diameter beads using a 25× objective with effective numerical aperture (NA) of 0.63. To investigate the temporal characteristics of the scan unit, a bright and a dark spot was selected within the FOV as targets. The phase modulator was set to update at 100 kHz, while the fluorescence intensity was acquired at 2 MHz. The time course of fluorescence intensity over two such cycles is shown in FIG. 8B, showing a 10-90% switching time of 2.75 μs±0.25 μs. To further quantify switching efficiency, the maximum and mean signal 48, 50 at varying SLM refresh rates was investigated. The SLM update rate was set to integer divisors of the data acquisition rate (1020 kHz), up to 340 kHz. The maximum and mean signal 48, 50 at the bright target normalized to the maximum intensity value at the lowest SLM refresh rate, in this case 10 kHz, was determined. For 340 kHz, the fluorescence reaches 77% of the maximum at lower rates. The average signal decreases linearly and reaches 37% of the maximum at 340 kHz, while at 50 kHz it is still at almost 92% (see FIG. 8C). This means that at this speed, only 8% of the signal is lost due to switching time.

Fast 3D random access scanning is particularly suited for imaging neuronal activity. This was demonstrated by measuring glutamate release with the glutamate sensor iGluSnFR3 in organotypic slices and zebrafish larvae in vivo. To resolve finer structures and increase power density at the focus, the objective was replaced by 40×/0.8 NA objective (NTR Apo 40×/0.8 W, Nikon), which reduces the FOV to 25×75×120 μm.

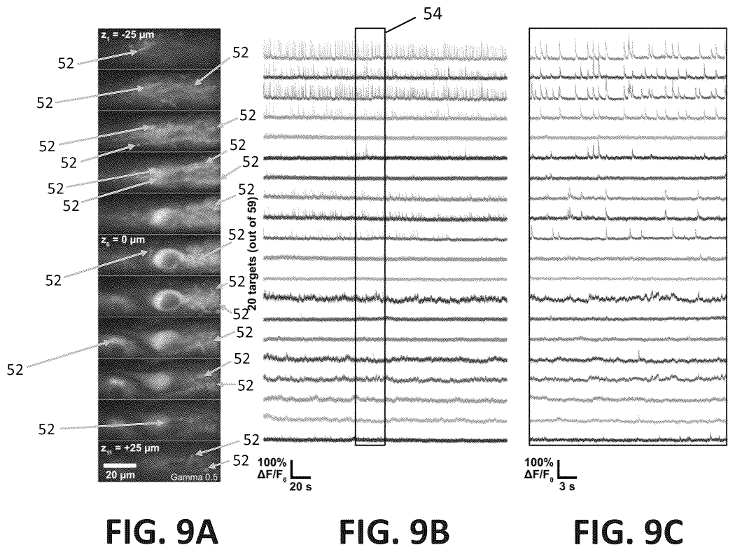

Glutamate in mouse organotypic hippocampal slice cultures was imaged as shown in FIGS. 9A-9C. FIG. 9A shows a raster-scanned overview stack with 5 μm Z-step size, which formed the basis for manual location selection (blue) dots 52. Fluorescence was then recorded at these 59 locations at a pixel rate of 250 kHz. Selected traces showing the change in fluorescence dF/F0 in response to glutamate release at these locations are shown in FIG. 9B. Each trace corresponds to a single pixel without any spatial averaging. dF/F traces over four minutes show little to no bleaching (18 mW excitation power at sample). For display, traces were filtered with a rolling average window of size 50. FIG. 9C shows a 30-second excerpt of the whole recording corresponding to the (black) boxed region 54 in FIG. 9B.

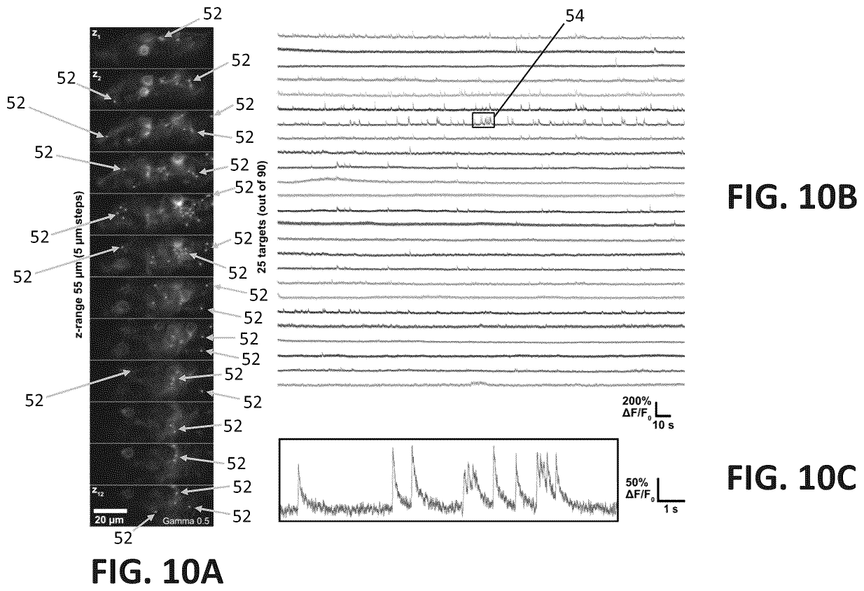

For in vivo imaging of zebrafish larvae, iGluSnFR3 in neurons was transiently expressed. FIG. 10A is a raster scanned overview stack of part of the olfactory bulb of a 3 dpf zebrafish larva. A Gamma correction was applied to emphasize dimmer structures. Manually selected targets for random-access scanning are marked as (blue) dots 52. Fish were paralyzed and overall activity was increased using pentylenetetrazol (PTZ). FIG. 10B shows a representative raster-scanned overview stack of labeled neurons in the olfactory bulb. Ninety targets were manually selected and observed for 240 s (FIG. 10B) at 340 kHz refresh rate and 26 mW laser power. For display, traces were filtered with a rolling average window of size 68. FIG. 10C shows a zoom of the highlighted region 54 in FIG. 10B.

### Microscope

The microscope setup comprised a 80 MHz femtosecond pulsed laser with included dispersion compensation (MaiTai DeepSee, Spectra-Physics), the scanning module 30 described above, the objective, a detection path and a widefield path for convenient FOV selection.

The laser beam, expanded to 10 mm diameter using a 5× beam expander (GBE05-B, Thorlabs), enters the scanning module 30. The SLM plane of the scanning module 30 is then imaged onto the back focal plane of the objective with unit magnification using two achromatic lenses as scan 28 and tube lens (AC508-200-B-ML, Thorlabs).

A dichroic mirror (DMLP650L, Thorlabs) separates excitation and emission light. After a bandpass filter (BrightLine 525/50, Semrock), light is detected by a PMT (H10770PA-40 MOD, Hamamatsu), amplified (DHPCA-100, Femto) and detected using a data acquisition card (NI USB-6363, National Instruments). Scanning and data acquisition are synchronized at up to 340 kHz refresh rate and 2 MHz analog input rate using a digital output trigger. The microscope is controlled with software written in Python.

The scanning module 30 was designed for a wavelength of 940 nm, optimized for the GFP-based glutamate indicator iGluSnFR3, but can be used at wavelengths in the range of 700-1000 nm with minor changes of alignment.

### SLM Calibration

The SLM pixels comprise ribbons that can be electrostatically actuated by an electrode, resulting in a phase modulation of the reflected light equivalent to twice the ribbon deflection, i.e. a 2π phase delay for a deflection of half the wavelength. Similar to other phase modulators, because of the use of phase wrapping, (approximately) monochromatic light was employed.

The electrode voltage is proportional to a 10-bit pixel value. As the deflection does not scale linearly with the applied voltage, this is calibrated. Binary gratings with a range of possible pixel values are applied by varying the pixel value of every other pixel. The deflection d as a function of voltage V can be approximated by d(V)=A·V⁴, where A is a scalar constant (see, e.g., https://www.siliconlight.com/en/technology/iv-response.html), which was experimentally determined to be 690.

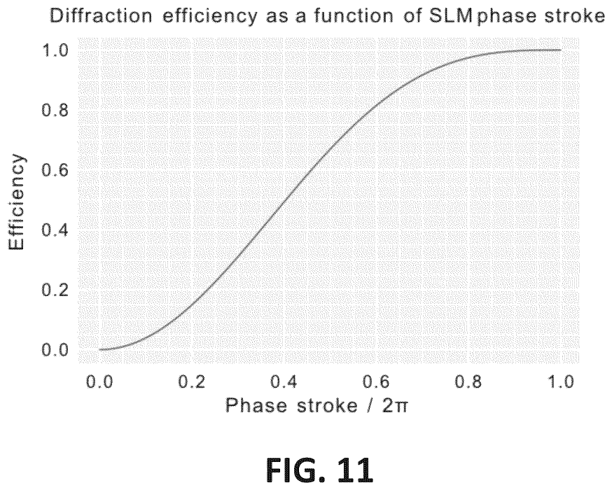

Calibration shows a maximum stroke of 0.77π at 940 nm, which reduces the diffraction efficiency only by around 50%. See FIG. 11 discussed below.

Phase patterns (from 0 to 2π) are set to the closest accessible value, i.e. symmetrically clipped at the low and high phase values. As absolute phase does not matter, the range (1±0.77/2)π, i.e. (0.62π to 1.39π) is displayed in the range from 0 to 0.77π. All values below are set to 0, while values above are set to the maximum, 0.77π.

### Adaptive Optics Implementation

To determine the system correction pattern, a modal adaptive optics approach with approximated Zernike polynomials was used.

Iterating through all Zernike polynomials could be approximated by linearly separable patterns in X and Y with Noll index up to 14. For each Zernike polynomial, the normalized pattern is applied on the phase modulator, multiplied by factors in the range from −5 to 5 in increments of 0.2. Fluorescence intensity of 1 μm beads or bead clusters was determined at 1 kHz SLM refresh rate and the pattern at maximum intensity was determined. This pattern was kept constant while the next mode was added to it. After all modes were optimized once, a second iteration was performed. The correction pattern determined in the first iteration was applied and only a single mode removed, which was then re-optimized.

### Sample Preparation

### Organotypic Slice Culture Preparation

350 mm-thick organotypic hippocampal slice cultures were prepared from P6 to P9 WT C57 mice of either sex. Slices were prepared on filter paper according to the interface method (Stoppini et al., 1991; De Simoni and Yu, 2006) and cultured in a MEM-based mouse slice culture medium, with the addition of 15% Horse Serum; 1×B27; 25 mM HEPES; 3 mM L-Glutamine; 2.8 mM CaCl2); 1.8 mM MgSO4; 0.25 mM Ascorbic Acid; 6.5 g/L D-Glucose, adjusted at pH 7.3. 3 days after plating, the medium was replaced and then exchanged every 4 days. Cultures were maintained in an incubator with 5% CO2 at 34° C.

Plamids pAAV.hSyn-iGluSnFR3.v857.GPI (Addgene #178331) and pAAV.hSyn.iGluSnFR3.v857.SGZ (Addgene #178330) were from Kaspar Podgorski. The Charite Viral Core Facility manufactured adeno-associated viruses (AAVs). Organotypic hippocampal slice cultures were infected with AAVs at 7-10 days slice culture. Each construct was mixed with mouse slice culture medium to reach 20 μl final volume and pipetted directly on top of the slices. Two photon imaging was performed at 16-23 days slice culture in artificial cerebrospinal fluid (aCSF: 145 mM NaCl, 2.5 mM KCl, 10 mM HEPES, 1 mM MgCl2, 2 mM CaCl2), 10 mM glucose; pH 7.3), containing 10 mM KCl and 0.2 mM 4-Aminopyridine (4-AP).

### Zebrafish

iGluSnFR3.GPI was transiently expressed by injecting approximately 20 pg HuC:iGluSnFR3.GPI plasmid DNA into one cell stage zebrafish casper embryos (roy^{-/-}; nacre^{-/-}). Larvae were screened for iGluSnFR expression at 3 days post fertilization (dpf), paralyzed by immersion in 1 mg/mL a-bungarotoxin for 2-4 minutes and embedded in 1.5% low melting point agarose. To increase overall activity, pentylenetetrazol (PTZ) was added at a final concentration of 20 mM at least 10 minutes prior to starting an imaging session.

All animal experiments conformed to Berlin state, German federal and European Union animal welfare regulations and were approved by the LAGeSo, the Berlin admission authority for animal experiments.

### Trace Analysis

The baseline fluorescence F0 was assumed to be constant over the measurement time and approximated as the median over the entire trace. dF/F was then computed as dF/F=(F(t)−F0)/F0.

### Additional Discussion

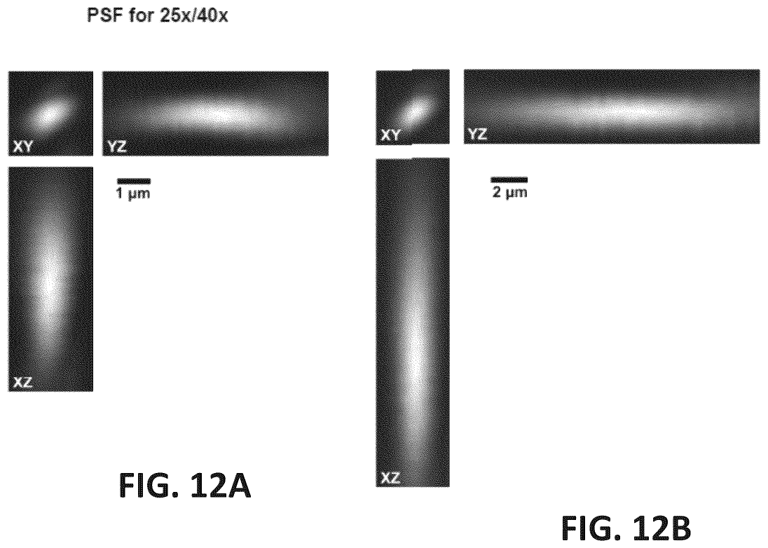

When calibrating the relationship between command signal and optical phase retardance, the effective maximum optical path length stroke was determined to be ˜400 nm, in agreement with its design for blue wavelengths. This corresponds to a phase stroke of ˜0.8 π at a wavelength of 940 nm (at the incidence angle used in our setup), and may at first appear to rule out any use with NIR light. However, even limited stroke leads to noticeable diffraction efficiency, which was calculated to be nearly 50% of its maximum value as shown in FIG. 12. FIG. 12 is a plot showing diffraction efficiency as a function of maximum phase stroke. Numerical simulation assumes a target pattern (focused spot), which is Fourier transformed, the phase range clipped and then transformed back. The efficiency is the energy in the new target pattern normalized to the old. See also Tzang, O. et al. Wavefront shaping in complex media with a 350 kHz modulator via a 1D-to-2D transform, Nat. Photonics 13, 788-793 (2019). Due to the combined effects of diffraction efficiency, two reflections and phase modulations, as well as transmission losses, the overall power efficiency of the scan unit is approximately 5%. However, given that commercially available fs-pulsed light sources output powers of several Watts, this efficiency was sufficient even for in vivo experiments such as described herein.

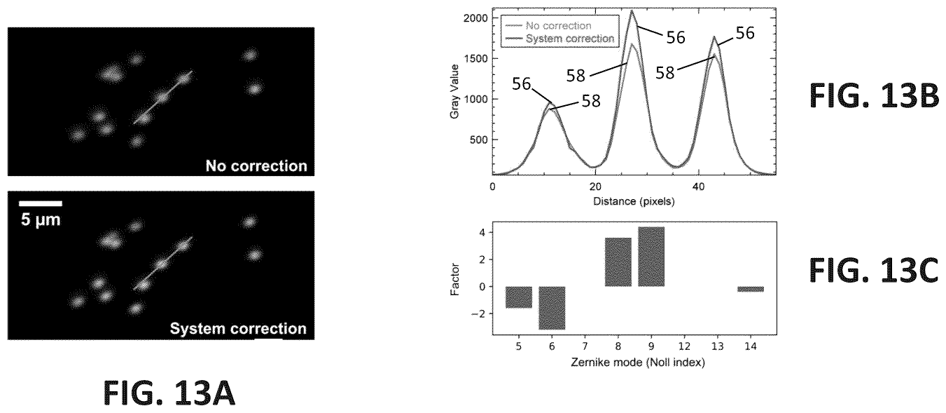

FIGS. 12A and 12B shows point spread functions (PSF) for 25×/40× objectives. Maximum intensity projections in the XY, XZ and YZ planes using a 40×/0.8NA objective (FWHM x: 1.0 μm, y: 0.8 μm, z: 3.5 μm) are shown in FIG. 13A and using a 25× objective with effective illumination NA of 0.63 due to underfilling (FWHM x: 1.6 μm, y: 1.3 μm, z: 9.3 μm) are shown in FIG. 12B. For both objectives, the point spread function after system correction is shown in FIGS. 12A and 12B.

A modal adaptive optics algorithm (see, Galwaduge, P. T., Kim, S. H., Grosberg, L. E. & Hillman, E. M. C. Simple wavefront correction framework for two-photon microscopy of in-vivo brain. Biomed. Opt. Express 6, 2997 (2015)) based on fluorescence intensity was used to correct for linearly separable system aberrations. FIGS. 13A-13C illustrate adaptive optics for system correction. FIG. 13A is a raster-scanned overview of 1 μm beads (yellow-green FluoSpheres, ThermoFisher) dispersed in agarose. Images are a maximum intensity projection of 9 planes spaced 1 μm apart to reduce the effects of a slight shift in the focal plane. FIG. 13B includes profiles along the lines shown in FIG. 13A, showing an increase in signal after system correction (red curve) 56 as compared to no correction (grey curve) 58. FIG. 13C shows contributions of individual Zernike polynomials to the system correction, which can be approximated by a linearly separable pattern. Numbers correspond to Noll indices: 5—vertical astigmatism, 6—vertical trefoil, 7—vertical coma, 8—horizontal coma, 9—oblique trefoil, 12—1st spherical aberration, 13—vertical 2nd astigmatism, 14—vertical quadrafoil. Equations and approximations can be found in Akemann, W. et al. Fast spatial beam shaping by acousto-optic diffraction for 3D non-linear microscopy, Opt.Express 23, 28191 (2015).

The PSF shown in FIGS. 12A and 12B is not diffraction-limited. This is due to aberrations which are not linearly separable, and thus cannot be corrected by the scanning module 30, as well as chromatic aberration due to the acylindrical lens. In the future, this could be improved by a custom achromatic cylindrical instead of an off-the shelf acylindrical lens.

The FOV was determined for a 25× objective (Leica HC Fluotar L 25×/0.95 W VISIR; effective NA 0.63) by imaging fluorescent beads dispersed in agarose. (See, e.g., FIG. 8A, using 1 μm yellow-green FluoSpheres, ThermoFisher). As previously discussed, the scan range along the short lateral axis is limited by the height of the pixels. While the reported usable height (with guaranteed phase stroke) is only 75 μm, the ribbon-based MEMS pixels were found to have a much larger usable height of up to ˜160 μm.

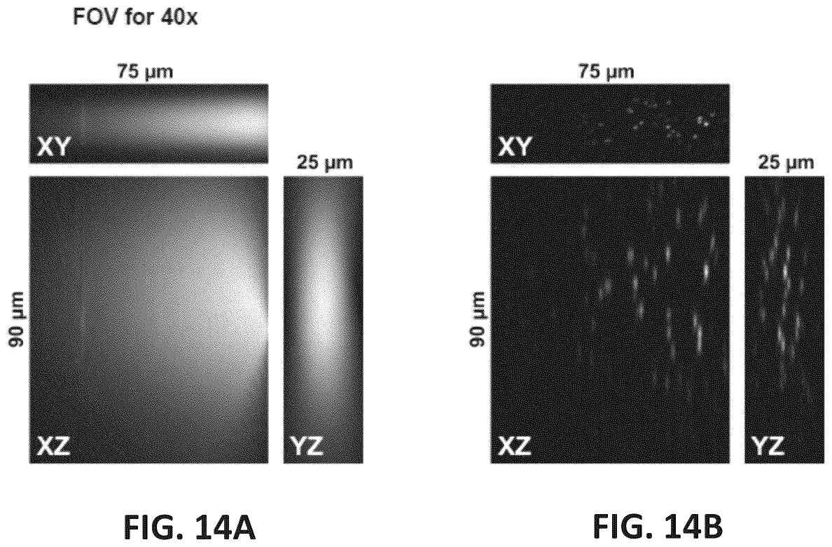

The FOV using a 40×/0.8 NA objective is shown in FIGS. 14A and 14B. FIG. 14A shows Maximum intensity projections along all three axes visualized using a fluorescein solution. FIG. 14B shows FOV visualization using 1 μm diameter beads (yellow-green FluoSpheres, ThermoFisher).

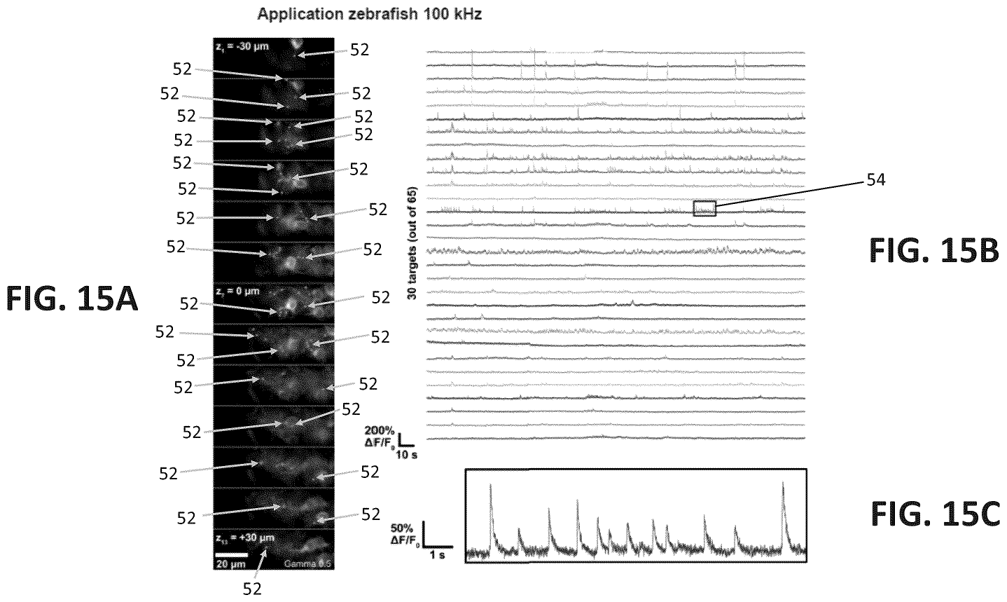

FIG. 15A-15C show application to zebrafish at 100 kHz. In particular, FIGS. 15A-15C show 3D random access microscopy using iGluSnFR3 in larval zebrafish olfactory bulb at a 100 kHz refresh rate. FIG. 15A is a raster scanned overview stack of part of the olfactory bulb of a 4 dpf zebrafish larva. A Gamma correction was applied to emphasize dimmer structures. Manually selected targets for random-access scanning are marked as blue dots 52. FIG. 15B shows change in fluorescence dF/F0 acquired at 100 kHz. A 20 point moving average is applied. FIG. 15C is a zoom in of the region in FIG. 15B marked with a (black) rectangle 54.

Accordingly, a mechanism for 3D random-access scanning at refresh rates exceeding 300 kHz is disclosed which is based on a single MEMS-based 1D phase modulator in a compact and low-cost module 30 that could be attached to existing multi-photon microscopes.

Although spatially or temporally multiplexed raster scanning methods can operate close to the fluorescence lifetime limit, this still imposes limits on the volume rate for large numbers of pixels. For single plane imaging of a large number of targets, line-scan tomographic methods such as scanned-line angular projection combine advantages of raster scanning and random access scanning, as they allow post hoc motion correction at high frame rates. However, kHz rate scanning is limited to 2D planes. By exclusively visiting sites of interest in rapid succession, random access scanning can reach much higher scanning rates. Compared to AOD-based scanning, the scanning speed is improved by nearly an order of magnitude, although currently at a smaller FOV.

Similar to other random access scanning methods, prior knowledge of the sample is used. Thus, a raster scan is performed before target selection. As this is not continuously updated, random access scanning is susceptible to motion artifacts. However, work using AODs has shown that it is possible to perform random access scanning even in awake, behaving animals using patch scanning or PSF shaping, which could also be possible using this SLM-based scanning mechanism. The faster refresh rate compared to AODs, as well as real-time control of the phase patterns, could also make closed-loop motion correction possible.

Except for a 3D-printed retroreflector mount, the example module uses only off-the-shelf components. In the future, performance could be optimized by using custom optical elements. First, the acylindrical lens optimized for 780 nm could be replaced by an achromatic cylindrical lens designed for the wavelength range around 900-940 nm, where many indicators can be excited. This would reduce chromatic aberrations as well as allow a shorter focal length, thus increasing the FOV. Second, the phase modulator is designed for visible light. A modulator with a higher phase stroke could improve the diffraction efficiency and thus the transmission of the scan unit by a factor of up to two (see, e.g., FIG. 11), leading to a four-fold improvement due to the two reflections.

A modal AO algorithm was used to correct for system aberrations in the setup. In principle, the same mechanism could be used to also correct low order sample aberrations such as the zebrafish head curvature.

As discussed previously, the FOV of scanning approach described herein may be limited by two factors. First, the number of SLM pixels which limit the number of different scan positions, and second, clipping on the edges of the linear phase modulator on the second reflection. In addition to increasing pixel number, it might be possible to manufacture taller pixels for a larger FOV along the short lateral dimension. Beyond this, combining random access scanning with galvo scanning, i.e. shifting the center of the SLM scanning range, could enhance the accessible FOV.

Random access scanning using AODs is finding wider application as faster and brighter fluorescent indicators and optogenetic actuators emerge. The approach presented here allowed for an increase in the scan rate of random access scanning by nearly an order of magnitude. The method enabled imaging iGluSnFR3, as one example of fast indicators of neuronal activity. In the future, this approach could potentially be used for fast calcium imaging, 2P voltage imaging or for 3D patterned photostimulation in conjunction with optogenetic actuators.

### Example Embodiments

Example embodiments described herein have several features, no single one of which is indispensable or solely responsible for their desirable attributes. A variety of example systems and methods are provided below.

### Part I

Example 1. A beam steering apparatus configured to receive a light beam having a cross-section orthogonal to propagation of said light beam, said cross-section extending along first and second orthogonal (x and y) axes, said beam propagating along a longitudinal (z) axis orthogonal to said first and second orthogonal axes, said apparatus comprising:
a 1D phase spatial light modulator having an elongate-shaped active area with a length in a first direction that is greater than a width in a second orthogonal direction, said active area configured to modulate the phase of light incident thereon,
optics comprising at least one anamorphic lens and a plurality of reflectors, said optics configured to:
(vi) focus said beam down in said second direction more than said first direction to form a first line focus on a first segment of said length of said active area of said 1D phase spatial light modulator, said first line focus extending along said first axis of said beam cross-section,
(vii) increase collimation of light received from said first segment of said 1D phase spatial light modulator in said second direction,
(viii) rotate said beam cross-section azimuthally about said longitudinal axis such that said second axis is more aligned with said first direction than said second direction,
(ix) focus said beam down in said second orthogonal direction more than said first direction to form a second line focus on a second segment of said length of said active area of said 1D phase spatial light modulator, said second line focus extending along the second axis of said rotated beam cross-section,
increase collimation of said light received from said second segment of said 1D phase spatial light modulator in said second direction.

Example 2. The beam steering apparatus of Example 1, wherein said 1D phase spatial light modulator comprises a reflective 1D phase modulator.

Example 3. The beam steering apparatus of Example 2, wherein said 1D phase spatial light modulator comprise a MEMS reflector.

Example 4. The beam steering apparatus of Example 3, wherein said MEMS reflector comprises a plurality of reflective ribbons that can be displaced toward and/or away from an electrode.

Example 5. The beam steering apparatus of any of the examples above, wherein said 1D phase spatial light modulator has a refresh rate of at least 300 kHz.

Example 6. The beam steering apparatus of any of the examples above, wherein said beam steering apparatus is configured to reflect said beam from said first segment of said 1D phase spatial light modulator, rotate said beam azimuthally about said longitudinal axis of said beam, direct said beam back to said second segment of said 1D phase modulator.

Example 7. The beam steering apparatus of any of the examples above, wherein said plurality of reflectors are configured to reflect light reflected from said 1D phase spatial light modulator back to said 1D phase modulator.

Example 8. The beam steering apparatus of Example 7, said plurality of reflectors are arranged to rotate said beam cross-section by 80-110°.

Example 9. The beam steering apparatus of Example 7, said plurality of reflectors are arranged to rotate said beam cross-section by 90°.

Example 10. The beam steering apparatus of any of the examples above, wherein said anamorphic lens comprises a cylindrical lens or an acylindrical lens.

Example 11. The beam steering apparatus of any of the examples above, wherein said anamorphic lens comprises an achromatic cylindrical lens.

Example 12. The beam steering apparatus of any of the examples above, wherein said anamorphic lens is disposed such that said light beam is transmitted through said anamorphic lens both when incident on said 1D phase spatial light modulator and when reflected therefrom.

Example 13. The beam steering apparatus of any of said examples above, wherein said plurality of reflectors comprise first and second reflectors arranged with respect to each other along a diagonal to said first and second directions so as to azimuthally rotate said beam cross-section.

Example 14. The beam steering apparatus of any of Example 13, wherein said first reflector is disposed to receive light focused on said first portion of said 1D phase spatial light modulator and to reflect light from said first portion of said 1D phase modulator onto said second reflector.

Example 15. The beam steering apparatus of Example 14, wherein said second reflector is disposed to reflect light from said first reflector onto said second portion of said 1D phase spatial light modulator.

Example 16. The beam steering apparatus of any of the examples above, wherein said at least one anamorphic lens comprises an anamorphic lens and wherein said plurality of reflectors are configured such that said light beam passes through a first quadrant of said anamorphic, is reflected from said first segment of said 1D phase spatial light modulator through a second quadrant of said anamorphic lens, is reflected from said plurality of reflectors through a third quadrant of said anamorphic lens and is reflected from said 1D phase modulator through a fourth quadrant of said anamorphic lens.

Example 17. The beam steering apparatus of any of Examples 13-15, further comprising a retroreflector stage supporting said first and second reflectors and including a hole therein for ingress and egress of said light beam to and from said 1D phase spatial light modulator.

Example 18. The beam steering apparatus of any of the claims above, further comprising a microscope objective, said 1D phase spatial light modulator imaged to a back focal plane of said microscope objective.

Example 19. The beam steering apparatus of Example 18, further comprising achromatic lenses configured to images said 1D phase spatial light modulator onto said back focal plane of said microscope objective.

Example 20. The beam steering apparatus of Example 19, further comprising an aperture at a focal plane of one of said achromatic lenses configured to block unmodulated light and/or one or more unwanted diffractive orders.

Example 21. The beam steering apparatus of any of Examples 19-20, wherein said achromatic lenses are configured for chromatic aberration correction in a range of 900-940 nm.

Example 22. The beam steering apparatus of any of the examples above, further comprising a galvometer configured to shift scanning thereby enlarging field of view.

Example 23. The beam steering apparatus of any of Examples 1-22, further comprising electronics electrically connected to said 1D phase spatial light modulator configured to provide signals to said 1D phase modulator to provide 3D random access point steering.

Example 24. The beam steering apparatus of any of Examples 1-22, further comprising electronics electrically connected to said 1D phase spatial light modulator, said electronics configured to provide for random access point steering comprising steering said beam in the first and second lateral directions and providing defocus.

Example 25. The beam steering apparatus of Example 23 or 24, wherein said electronics is further configured to provide adaptive optical correction by causing the 1D phase spatial light modulator to offset aberration in the system.

Example 26. The beam steering apparatus of any of Examples 23-25, wherein said electronics is further configured to provide adaptive optical correction by causing the 1D phase spatial light modulator to offset aberration in the sample.

Example 27. The beam steering apparatus of any of Examples 23-26, wherein said electronics is further configured to provide motion correction.

Example 28. The beam steering apparatus of any of Examples 23-27, wherein said electronics is further configured to provide motion correction using use patch scanning, PSF shaping, real time control of phase patterns, closed-loop motion correction or any combination of these.

Example 29. The beam steering apparatus of any of Examples 23-28, wherein said electronics and said 1D phase modulator are configured such that said beam steering apparatus can provide 3D random-access scanning at refresh rates of exceeding 320 kHz.

Example 30. The beam steering apparatus of any of Examples 23-28, wherein said electronics and said 1D phase modulator are configured such that said beam steering apparatus can provide 3D random-access scanning at refresh rates of exceeding 300 kHz.

Example 31. The beam steering apparatus of any of the examples above, further comprising a pulsed laser light source configured to provide light for said light beam.

Example 32. The beam steering apparatus of any of the examples above, wherein said first and second segments each extends along 40-60% of the length of said 1D phase spatial light modulator.

Example 33. The beam steering apparatus of any of the examples above, wherein said first and second segments each extends along about half of the length of said 1D phase spatial light modulator.

Example 34. A multi photon fluorescence microscope comprising the apparatus of any of the examples above.

Example 35. The multiphoton fluorescence microscope of Example 33, further comprising a laser light source.

Example 36. The multi photon fluorescence microscope of Example 33 or Claim 34, further comprising a microscope objective.

Example 37. A 3D printer comprising the beam steering of any of the examples above.

### Part II

Example 1. A beam steering apparatus configured to receive a light beam, said apparatus comprising:
a single 1D phase spatial light modulator having an elongate-shaped active area with a length in a first direction that is greater than a width in a second orthogonal direction, said active area configured to modulate the phase of light incident thereon;
at least one anamorphic lens configured to focus said beam down more in one direction than an orthogonal direction to form a first line focus along said length of said active area of said 1D phase spatial light modulator; and
electronics configured to adjust said 1D phase spatial light modulator to steer said beam in two orthogonal lateral directions (x and y) and focus said beam at different distances in a third longitudinal direction (z) in a manner so as to provide 3D random access point scanning.

Example 2. The beam steering apparatus of Example 1, wherein said 1D phase spatial light modulator comprises a reflective 1D phase spatial light modulator.

Example 3. The beam steering apparatus of Example 2, wherein said 1D phase spatial light modulator comprise a MEMS reflector.

Example 4. The beam steering apparatus of Example 3, wherein said MEMS reflector comprises a plurality of reflective ribbons that can be displaced toward and/or away from an electrode.

Example 5. The beam steering apparatus of any of any of the examples above, wherein said at least one anamorphic lens is disposed such that said light beam is transmitted through said anamorphic lens both when incident on said 1D phase spatial light modulator and when reflected therefrom.

Example 6. The beam steering apparatus of any of the examples above, wherein said 1D phase spatial light modulator has a refresh rate of at least 300 kHz.

Example 7. The beam steering apparatus of any of the examples above, wherein said at least one anamorphic lens comprises a cylindrical lens or an acylindrical lens.

Example 8. The beam steering apparatus of any of the examples above, wherein said at least one anamorphic lens comprises an achromatic cylindrical lens.

Example 9. The beam steering apparatus of any of the examples above, wherein said beam steering apparatus is configured to focus said beam on a first segment of said 1D phase spatial light modulator, to rotate said beam about a longitudinal axis of said beam, and to focus said beam on a second segment of said 1D phase modulator different from said first segment.

Example 10. The beam steering apparatus of Example 9, wherein said first and second segments each extends along 40-60% of the length of said 1D phase spatial light modulator.

Example 11. The beam steering apparatus of Example 9, wherein said first and second segments each extends along about half of the length of said 1D phase spatial light modulator.

Example 12. The beam steering apparatus of any of the examples above, further comprising a plurality of reflectors configured to rotate said beam about a longitudinal axis of said beam along the direction of propagation of the beam.

Example 13. The beam steering apparatus of Example 12, wherein said plurality of reflectors are arranged to rotate said beam by 80-110° about said longitudinal axis of said beam.

Example 14. The beam steering apparatus of Example 12, wherein said plurality of reflectors are arranged to rotate said beam by 90° about said longitudinal axis of said beam.

Example 15. The beam steering apparatus of any of Examples 12-14, wherein said plurality of reflectors comprise first and second reflectors, said first reflector disposed to receive light focused on a first segment of said 1D phase spatial light modulator and to reflect light from said first segment of said 1D phase modulator onto said second reflector.

Example 16. The beam steering apparatus of Example 15, said second reflector is disposed to reflect light from said first reflector onto a second segment of said 1D phase spatial light modulator different from said first segment.

Example 17. The beam steering apparatus of any of Examples 12-14, wherein said plurality of reflectors comprise first and second reflectors arranged with respect to each other along a diagonal to said length of said 1D phase spatial light modulator so as to azimuthally rotate said beam about said longitudinal axis.

Example 18. The beam steering apparatus of any of the examples above, further comprising a microscope objective, said 1D phase spatial light modulator imaged to a back focal plane of said microscope objective.

Example 19. The beam steering apparatus of Example 18, further comprising achromatic lenses configured to images said 1D phase spatial light modulator onto said back focal plane of said microscope objective.

Example 20. The beam steering apparatus of Example 19, further comprising an aperture at a focal plane of one of said achromatic lenses configured to block unmodulated light and/or one or more unwanted diffractive orders.

Example 21. The beam steering apparatus of Examples 19 or 20, wherein said achromatic lenses are configured for chromatic aberration correction in a range of 900-940 nm.

Example 22. The beam steering apparatus of any of said claims above, further comprising a galvometer configured to shift scanning thereby enlarging field of view.

Example 23. The beam steering apparatus of any of said examples above, wherein said electronics is further configured to provide adaptive optical correction by causing the 1D phase spatial light modulator to offset aberration in the system.

Example 24. The beam steering apparatus of any of said examples above, wherein said electronics is further configured to provide adaptive optical correction by causing the 1D phase spatial light modulator to offset aberration in the sample.

Example 25. The beam steering apparatus of any of said examples above, wherein said electronics is further configured to provide motion correction.

Example 26. The beam steering apparatus of any of said examples above, wherein said electronics is further configured to provide motion correction using use patch scanning, PSF shaping, real time control of phase patterns, closed-loop motion correction or any combination of these.

Example 27. The beam steering apparatus of any of said examples above, wherein said electronics and said 1D phase spatial light modulator are configured such that said beam steering apparatus can provide 3D random-access scanning at refresh rates of exceeding 320 kHz.

Example 28. The beam steering apparatus of any of said examples above, wherein said electronics and said 1D phase spatial light modulator are configured such that said beam steering apparatus can provide 3D random-access scanning at refresh rates of exceeding 300 kHz.

Example 29. The beam steering apparatus of any of said examples above, further comprising a pulsed laser light source configured to provide light for said light beam.

Example 30. A multi photon fluorescence microscope comprising the apparatus of any of said claims above.

Example 31. The multi photon fluorescence microscope of Example 29, further comprising a laser light source.

Example 32. The multi photon fluorescence microscope of Example 29 or 30, further a microscope objective.

Example 33. A 3D printer comprising the beam steering of any of said examples above.

### Part III

Example 1. A beam steering apparatus configured to receive a light beam, said apparatus comprising:
at least one 1D phase spatial light modulator having an elongate-shaped active area with a length in said first direction that is greater than a width in said second orthogonal direction, said active area configured to modulate the phase of light incident thereon;
at least one anamorphic lens configured to focus said beam down more in one direction than in an orthogonal direction to form a first line focus on said length of said active area of said at least one 1D phase spatial light modulator; and
electronics configured to adjust said at least one 1D phase spatial light modulator to steer said beam in two lateral directions (x and y) and focus said beam at different distances along a third direction (z) in a manner so as to provide 3D random access point scanning.

Example 2. The beam steering apparatus of Example 1, wherein said electronics and said at least one 1D phase spatial light modulator are configured such that said beam steering apparatus can provide 3D random-access point scanning at refresh rates of exceeding 300 kHz.

Example 3. The beam steering apparatus of Example 1 or 2, wherein said at least one 1D phase spatial light modulator comprises first and second 1D phase spatial light modulators oriented orthogonal with respect to each other so as to be crossed.

Example 4. The beam steering apparatus of Example 3, wherein said at least one anamorphic lens comprises a first anamorphic lenses for focusing said light beam onto said first 1D phase spatial light modulator and a second anamorphic lens for focusing said light beam onto said second 1D phase spatial light modulator.

Example 5. The beam steering apparatus of Example 3, wherein said at least one anamorphic lens further comprises a third anamorphic lenses for collimating light from said first 1D phase spatial light modulator and a fourth anamorphic lenses for collimating light from said second 1D phase spatial light modulator.

Example 6. The beam steering apparatus of any of the examples above, wherein said 1D phase spatial light modulator comprises a reflective 1D phase spatial light modulator.

Example 7. The beam steering apparatus of Example 6, wherein said 1D phase spatial light modulator comprise a MEMS reflector.

Example 8. The beam steering apparatus of Example 7, wherein said MEMS reflector comprises a plurality of reflective ribbons that can be displaced toward and/or away from an electrode.

Example 9. The beam steering apparatus of any of the examples above, wherein said 1D phase spatial light modulator has a refresh rate of at least 300 kHz.

Example 10. The beam steering apparatus of any of the examples above, wherein said at least one anamorphic lens comprises a cylindrical lens or an acylindrical lens.

Example 11. The beam steering apparatus of any of the examples above, wherein said at least one anamorphic lens comprises an achromatic cylindrical lens.

Example 12. The beam steering apparatus of any of Examples 1 and 6-11, wherein said beam steering apparatus is configured to focus said beam on a first segment of said 1D phase spatial light modulator, to rotate said beam about a longitudinal axis of said beam along the direction of propagation of the beam, and to focus said beam on a second segment of said 1D phase modulator different from said first segment.

Example 13. The beam steering apparatus of Example 12, wherein said first and second segments each extends along 40-60% of the length of said 1D phase spatial light modulator.

Example 14. The beam steering apparatus of Example 12, wherein said first and second segments each extends along about half of the length of said 1D phase spatial light modulator.

Example 15. The beam steering apparatus of any of Examples 12-14, further comprising a plurality of reflectors configured to rotate said beam about said longitudinal axis of said beam.

Example 16. The beam steering apparatus of Example 15, wherein said plurality of reflectors are arranged to rotate said beam by 80-110° about said longitudinal axis of said beam.

Example 17. The beam steering apparatus of Example 15, wherein said plurality of reflectors are arranged to rotate said beam by 90° about said longitudinal axis of said beam.

Example 18. The beam steering apparatus of any of the examples above, further comprising a microscope objective, said at least one 1D phase spatial light modulator imaged to a back focal plane of said microscope objective.

Example 19. The beam steering apparatus of Example 18, further comprising achromatic lenses configured to image said at least one 1D phase spatial light modulator onto said back focal plane of said microscope objective.

Example 20. The beam steering apparatus of Example 19, further comprising an aperture at a focal plane of one of said achromatic lenses configured to block unmodulated light and/or one or more unwanted diffractive orders.

Example 21. The beam steering apparatus of any of Examples 19-20, wherein said achromatic lenses are configured for chromatic aberration correction in a range of 900-940 nm.

Example 22. The beam steering apparatus of any of said examples above, further comprising a galvometer configured to shift scanning thereby enlarging field of view.

Example 23. The beam steering apparatus of any of said examples above, wherein said electronics is further configured to provide adaptive optical correction by causing the 1D phase spatial light modulator to offset aberration in the system.

Example 24. The beam steering apparatus of any of said examples above, wherein said electronics is further configured to provide adaptive optical correction by causing the 1D phase spatial light modulator to offset aberration in the sample.

Example 25. The beam steering apparatus of any of said examples above, wherein said electronics is further configured to provide motion correction.

Example 26. The beam steering apparatus of any of said examples above, wherein said electronics is further configured to provide motion correction using use patch scanning, PSF shaping, real time control of phase patterns, closed-loop motion correction or any combination of these.

Example 27. The beam steering apparatus of any of said examples above, further comprising a pulsed laser light source configured to provide light for said light beam.

Example 28. A multi photon fluorescence microscope comprising the apparatus of any of said examples above.

Example 29. The multi photon fluorescence microscope of Example 28, further comprising a laser light source.

Example 30. A 3D printer comprising the beam steering of any of said examples above.

### Part IV

Example 1. A beam steering apparatus configured to receive a light beam, said apparatus comprising:
at least one phase spatial light modulator;
at least one optical element configured to focus said beam onto said at least one phase spatial light modulator; and
electronics configured to adjust said at least one phase spatial light modulator to steer said beam in two lateral directions (x and y) and focus said beam at different distances along a third direction (z) in a manner so as to provide 3D random access point scanning,
wherein said electronics and said at least one phase spatial light modulator are configured such that said beam steering apparatus can provide 3D random-access point scanning at refresh rates of exceeding 300 kHz.

Example 2. The beam steering apparatus of Example 1, wherein said phase spatial light modulator has a refresh rate of at least 300 kHz.

Example 3. The beam steering apparatus of Example 1 or 2, wherein said at least one optical element configured to focus said beam onto said at least one phase spatial light modulator comprises a lens.

Example 4. The beam steering apparatus of any of the examples above, further comprising a microscope objective, said phase spatial light modulator imaged to a back focal plane of said microscope objective.

Example 5. The beam steering apparatus of Example 4, further comprising achromatic lenses configured to image said phase spatial light modulator onto said focal plane of said microscope objective.

Example 6. The beam steering apparatus of Example 5, further comprising an aperture at a focal plane of one of said achromatic lenses configured to block unmodulated light and/or one or more unwanted diffractive orders.

Example 7. The beam steering apparatus of Example 5 or 6, wherein said achromatic lenses are configured for chromatic aberration correction in a range of 900-940 nm.

Example 8. The beam steering apparatus of any of said claims above, further comprising a galvometer configured to shift scanning thereby enlarging field of view.

Example 9. The beam steering apparatus of any of said examples above, wherein said electronics is further configured to provide adaptive optical correction by causing the phase spatial light modulator to offset aberration in the beam steering apparatus.

Example 10. The beam steering apparatus of any of said examples above, wherein said electronics is further configured to provide adaptive optical correction by causing the phase spatial light modulator to offset aberration in the sample.

Example 11. The beam steering apparatus of any of said examples above, wherein said electronics is further configured to provide motion correction.

Example 12. The beam steering apparatus of any of the examples above, wherein said electronics is further configured to provide motion correction using use patch scanning, PSF shaping, real time control of phase patterns, closed-loop motion correction or any combination of these.

Example 13. The beam steering apparatus of any of said examples above, further comprising a pulsed laser light source configured to provide light for said light beam.

Example 14. A multiphoton fluorescence microscope comprising the apparatus of any of said examples above.

Example 15. The multiphoton fluorescence microscope of Example 14, further comprising a laser light source.

Example 16. A 3D printer comprising the beam steering of any of said examples above.

Various configurations have been described above. Although this invention has been described with reference to these specific configurations, the descriptions are intended to be illustrative of the invention and are not intended to be limiting. Various modifications and applications may occur to those skilled in the art without departing from the true spirit and scope of the invention. For example, although the beam steering apparatus is discussed above in connection with microscopes such as fluorescence microscopes (e.g., two-photon fluorescence microscopes) the beam steering apparatus can be used in connection with other systems such as, for example, 3D printers. Thus, for example, in any method or process disclosed herein, the acts or operations making up the method/process may be performed in any suitable sequence and are not necessarily limited to any particular disclosed sequence. Features or elements from various embodiments and examples discussed above may be combined with one another to produce alternative configurations compatible with embodiments disclosed herein. Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

What is claimed is:

1. A beam steering apparatus configured to receive a light beam having a cross-section orthogonal to propagation of said light beam, said cross-section extending along first and second orthogonal (x and y) axes, said beam propagating along a longitudinal (z) axis orthogonal to said first and second orthogonal axes, said apparatus comprising:
a 1D phase spatial light modulator having an elongate-shaped active area with a length in a first direction that is greater than a width in a second orthogonal direction, said active area configured to modulate the phase of light incident thereon,
optics comprising at least one anamorphic lens and a plurality of reflectors, said optics configured to:
(i) focus said beam down in said second direction more than said first direction to form a first line focus on a first segment of said length of said active area of said 1D phase spatial light modulator, said first line focus extending along said first axis of said beam cross-section,
(ii) increase collimation of light received from said first segment of said 1D phase spatial light modulator in said second direction,
(iii) rotate said beam cross-section azimuthally about said longitudinal axis such that said second axis is more aligned with said first direction than said second direction,
(iv) focus said beam down in said second orthogonal direction more than said first direction to form a second line focus on a second segment of said length of said active area of said 1D phase spatial light modulator, said second line focus extending along the second axis of said rotated beam cross-section,
(v) increase collimation of said light received from said second segment of said 1D phase spatial light modulator in said second direction.

2. The beam steering apparatus of claim 1, wherein said 1D phase spatial light modulator comprises a reflective 1D phase modulator.

3. The beam steering apparatus of claim 2, wherein said 1D phase spatial light modulator comprise a MEMS reflector.

4. A multi photon fluorescence microscope comprising the apparatus of claim 1.

5. The multiphoton fluorescence microscope of claim 4, further comprising a laser light source.

6. The multi photon fluorescence microscope of claim 5, further comprising a microscope objective.

7. A 3D printer comprising the beam steering of claim 1.

8. A beam steering apparatus configured to receive a light beam, said apparatus comprising:
a single 1D phase spatial light modulator having an elongate-shaped active area with a length in a first direction that is greater than a width in a second orthogonal direction, said active area configured to modulate the phase of light incident thereon;
at least one anamorphic lens configured to focus said beam down more in one direction than an orthogonal direction to form a first line focus along said length of said active area of said 1D phase spatial light modulator; and
electronics configured to adjust said 1D phase spatial light modulator to steer said beam in two orthogonal lateral directions (x and y) and focus said beam at different distances in a third longitudinal direction (z) in a manner so as to provide 3D random access point scanning.

9. The beam steering apparatus of claim 8, wherein said 1D phase spatial light modulator comprises a reflective 1D phase spatial light modulator.

10. The beam steering apparatus of claim 9, wherein said 1D phase spatial light modulator comprise a MEMS reflector.

11. A multi photon fluorescence microscope comprising the apparatus of claim 8.

12. The multi photon fluorescence microscope of claim 11, further comprising a laser light source.

13. The multi photon fluorescence microscope of claim 12, further a microscope objective.

14. A 3D printer comprising the beam steering of claim 8.

15. A beam steering apparatus configured to receive a light beam, said apparatus comprising:
at least one 1D phase spatial light modulator having an elongate-shaped active area with a length in said first direction that is greater than a width in said second orthogonal direction, said active area configured to modulate the phase of light incident thereon;
at least one anamorphic lens configured to focus said beam down more in one direction than in an orthogonal direction to form a first line focus on said length of said active area of said at least one 1D phase spatial light modulator; and
electronics configured to adjust said at least one 1D phase spatial light modulator to steer said beam in two lateral directions (x and y) and focus said beam at different distances along a third direction (z) in a manner so as to provide 3D random access point scanning.

16. The beam steering apparatus of claim 15, wherein said electronics and said at least one 1D phase spatial light modulator are configured such that said beam steering apparatus can provide 3D random-access point scanning at refresh rates of exceeding 300 kHz.

17. The beam steering apparatus of claim 15, wherein said at least one 1D phase spatial light modulator comprises first and second 1D phase spatial light modulators oriented orthogonal with respect to each other so as to be crossed.

18. A multi photon fluorescence microscope comprising the apparatus of claim 15.

19. A 3D printer comprising the beam steering of claim 15.

20. A beam steering apparatus configured to receive a light beam, said apparatus comprising:
at least one phase spatial light modulator;
at least one optical element configured to focus said beam onto said at least one phase spatial light modulator; and
electronics configured to adjust said at least one phase spatial light modulator to steer said beam in two lateral directions (x and y) and focus said beam at different distances along a third direction (z) in a manner so as to provide 3D random access point scanning,
wherein said electronics and said at least one phase spatial light modulator are configured such that said beam steering apparatus can provide 3D random-access point scanning at refresh rates of exceeding 300 kHz.
